(19) United States
(12) Patent Application Publication
(10) Pub. No.: US 2012/0036090 A1
(43) Pub. Date: Feb. 9, 2012

(54) SYSTEM AND METHOD FOR PROVIDING DELIVERED PRICING

(76) Inventor: Bradley Skeen, Sugar Grove, IL (US)

(21) Appl. No.: 13/204,598

(22) Filed: Aug. 5, 2011

Related U.S. Application Data
(60) Provisional application No. 61/371,083, filed on Aug. 5, 2010.

(51) Int. Cl. G06Q 30/00

(52) U.S. Cl. 705/400

(57) ABSTRACT

Embodiments of the invention relate to a system, method, computer product and computer system for providing delivered pricing for at least one product. The method comprises receiving at least one delivery zone; providing at least one order threshold for the at least one product, including freight costs, the threshold the at least one order threshold based at least in part on a product unit cost and a freight cost based on the received destination zone; receiving a product quantity selection; providing preliminary delivered pricing based at least in part on the received product quantity selection; determining whether the preliminary delivered pricing meets or exceeds the at least one order threshold; and providing a total order cost, wherein the total order cost includes, the delivered pricing for at least one product based at least in part on the at least one delivery zone.

### CLAIM FOR PRIORITY

This application is related to, and claims priority from, U.S. Provisional Application No. 61/371,083 filed Aug. 5, 2010 titled “System and Method for Providing Delivered Pricing” the complete subject matter of which is incorporated herein by reference in its entirety.

### FIELD OF THE INVENTION

The invention relates to a system, method and computer readable storage medium for providing delivered shipping pricing. More particularly, the invention relates to a system, method and computer readable storage medium enabling customers to purchase items (packing products for example) at competitive (but profitable) prices without having to determine shipping costs after putting an order together. The resulting “delivered price” for each item would include both the item price and the necessary markup to cover the order shipment.

### BACKGROUND OF THE INVENTION

A number of factors make shipping unpredictable, including but not limited to: 1) orders are shipped to any number of different locations; 2) items are placed in varying quantities into orders; 3) items are priced differently from customer to customer; 4) item dimensions and weights vary widely across the catalog; 5) items are placed in varying combinations into orders; 6) each carrier provides a different rate using proprietary rules involving all of the above factors; and 7) each geographic destination potentially carries a materially different rate by volume or by weight to dictate the cost to move goods.

These factors make the prediction of shipping costs illusive at best. As a result, standard delivered pricing programs generally have either high risk or high margins that lead to noncompetitive prices.

For the foregoing reasons, there is a need for a system, method and computer readable storage medium for predicting or providing shipping costs.

### SUMMARY OF THE INVENTION

Embodiments of the invention relate to a system, method, computer product and computer system for providing delivered pricing for at least one product. The method comprises receiving at least one delivery zone; providing at least one order threshold for the at least one product, the at least one order threshold including freight costs, the threshold based at least in part on a product unit cost and a freight cost based on the received destination zone. The method further comprises receiving a product quantity selection; providing preliminary delivered pricing based at least in part on the received product quantity selection; determining whether the preliminary delivered pricing meets or exceeds the at least one order threshold; and providing a total order cost, wherein the total order cost includes, the delivered pricing for at least one product based at least in part on the at least one delivery zone.

Another embodiment relates a computer readable storage medium comprising computer executable instructions, which when executed by a computer cause the computer to perform a method for providing delivered pricing for at least one product. The computer readable storage medium comprises receiving at least one delivery zone; providing at least one order threshold for the at least one product, the at least one order threshold including freight costs, the threshold based at least in part on a product unit cost and a freight cost based on the received destination zone; receiving a product quantity selection; providing preliminary delivered pricing based at least in part on the received product quantity selection; determining whether the preliminary delivered pricing meets or exceeds the at least one order threshold; and providing a total order cost, wherein the total order cost includes, the delivered pricing for at least one product based at least in part on the at least one delivery zone.

A system for providing delivered pricing for at least one product, the system comprising a server having instructions operating thereon providing delivered pricing for at least one product, the instructions comprising receiving at least one zip code; providing at least one order threshold for the at least one product, the at least one order threshold based at least in part on a product unit cost and a freight cost based on the received destination zone; receiving a product quantity selection; providing preliminary delivered pricing based at least in part on the received product quantity selection; determining whether the preliminary delivered pricing meets or exceeds the at least one order threshold; and providing a total order cost, wherein the total order cost includes, the delivered pricing for at least one product based at least in part on the at least one delivery zone.

The foregoing and other features and advantages of the invention will become further apparent from the following detailed description of the presently preferred embodiment, read in conjunction with the accompanying drawings. The drawings are not to scale. The detailed description and drawings are merely illustrative of the invention rather than limiting, the scope of the invention being defined by the appended claims and equivalents thereof.

### BRIEF DESCRIPTION OF THE DRAWINGS

FIG. 1 depicts a schematic representation of a computer system in accordance with one embodiment of the present invention;

FIG. 2 depicts a screen shot of a log in screen in accordance with one embodiment of the present invention;

FIG. 3 depicts a screen shot of an account page screen in accordance with one embodiment of the present invention;

FIGS. 4A, 4B and 4C depict a screen shot of a quantity order screen in accordance with one embodiment of the present invention;

FIG. 5 depicts a screen shot of an alert screen in accordance with one embodiment of the present invention;

FIG. 6 depicts a screen shot of an alert and modified order screen in accordance with one embodiment of the present invention;

FIG. 7 depicts a screen shot of a confirmation screen in accordance with one embodiment of the present invention;

FIG. 8 depicts a screen shot of a final pricing and delivery screen in accordance with one embodiment of the present invention;

FIGS. 9A and 9B depict a detailed flow diagram of a method of providing delivered pricing.

Throughout the various figures, like reference numbers refer to like elements.

### DETAILED DESCRIPTION OF PRESENTLY PREFERRED EMBODIMENTS

One embodiment of the present invention relates to providing a method, system and computer readable storage medium for customers to purchase items (packing products for example, although other products are contemplated) at competitive (but profitable) prices without having to determine shipping costs after putting an order together. The resulting “delivered price” for each item would include both the item price and the necessary markup to cover the order shipment.

In addressing the inherent challenges to providing a delivered program, it was determined to bracket the most variable factors and devised a strategy to predict more exact pricing within the brackets.

### Brackets

Shipping Source & Destination

The method, system and computer readable storage medium program is segmented first based on the ship-to location. From the source location, the country is initially broken down into a plurality of Shipping Destination Zones (all zip codes (domestic and/or international) are contemplated but less than all zip codes are contemplated, 19 destination zones for example). The method, system and computer readable storage medium allows for additional zones to be applied, as well as for additional source addresses to be applied (in the event the shipper should move or start fulfilling orders through more than one location). Zoning is determined by a combination of distance and regional clustering to support popular shipping lanes.

Order Sizes & Item Quantities

Since orders can vary from a single item to a truckload of goods, bracketed order sizes are based on the total dollar amount of the order. Delivered Pricing Tiers were created to apply a delivered rate once a minimum price break is reached (initially $1,000 for example) and to adjust rates at price breaks if larger totals ($2,500, $5,000, etc.) are realized.

Item Pricing

There are a number of price classes in the existing pricing structure, so the program takes into account the different quantities necessary to build orders reaching each Delivered Pricing Tier.

Item Dimension & Weights

A packaging/palletizing optimization program was used to determine what quantity of a given product could fit into a maximum size/weight parcel and/or pallet to ensure the best possible shipping rates.

Item Combinations

To avoid restricting users to exclusively purchasing one item (or a pre-packaged combination of items) at a time, the combination of items within an order remained variable.

Carrier Rates

Carrier rates vary widely on many different factors. Based on some broad general rules regarding size and weight (maximum weight for parcel, etc), certain carrier services are programmatically excluded from some quotes.

Shipping Cost Prediction Strategy

Since every item in the catalog has its own unique dimensions and weight. Embodiments include a strategy to predict shipping costs for the items within orders for each bracketed Shipping Destination Zone and Delivered Pricing Tier. Final rates are fine tuned according to actual carrier rates as dictated by exact zip code.

In accordance with one embodiment, the method, system and computer readable storage medium create sample package-optimized orders per item, per Shipping Destination Zone, per Delivered Pricing Tier and/or threshold. The sample orders are run through another program that elicits shipping quotes from all applicable carriers. The rates are stored, and a per-unit price with associated shipping charges is calculated, to apply to the item for each item/Shipping Destination Zone/Delivered Pricing Tier combination in the Program.

Ordering Process

Unlike traditional ecommerce, in at least one embodiment, the method, system and computer readable storage medium for Packaging Delivered Pricing Program begins with the entry of the destination zip code. From this zip code, the method, system and computer readable storage medium sets the appropriate Shipping Destination Zone. Item prices displayed represent the first Delivered Pricing Tier in that Destination Zone. If the order subtotal grows to exceed the minimum requirement for a new Delivered Pricing Tier, prices in the cart are updated to represent that new Tier. The method, system and computer readable storage medium allows the customer to change the destination zip code at any time, with the understanding that the cart will be recalculated to present the pricing in a new Shipping Destination Zone if applicable. Upon checkout, the destination address must utilize the same zip code used during the building of the order.

Result:

Using the method, system and computer readable storage medium of the Packaging Delivered Pricing Program, customers can purchase items at competitive (but profitable) prices without having to determine shipping costs after putting an order together. Shipping quotes and carrier selection are no longer necessary in the user-experience, and the item rates cover the shipping costs to the desired destination without requiring a lofty overhead margin.

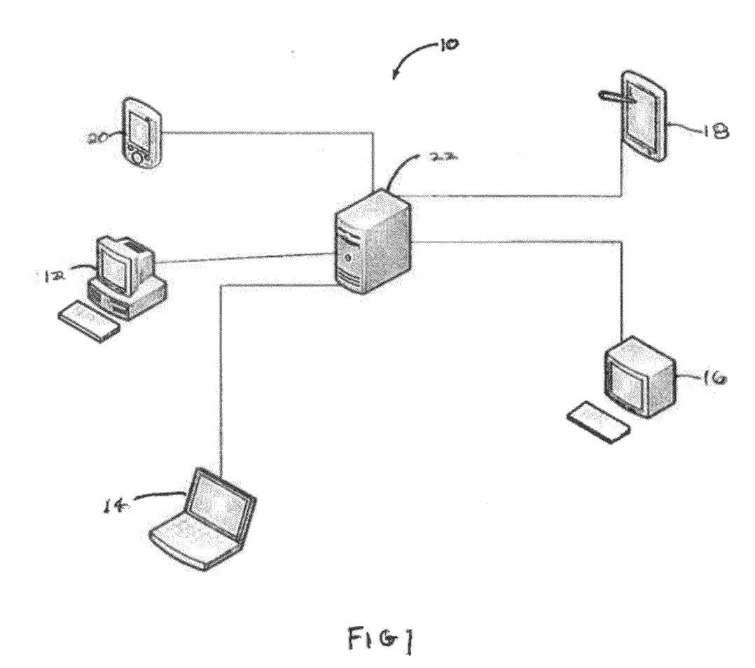

FIG. 1 provides a schematic representation of a computer system including instructions generally designated 10, for selling a business in accordance with one embodiment. FIG. 1 depicts a plurality of users communicating with the server 22 using one or more user interface devices via any hardwired or wireless communication network, including PCs 12 and 16, laptops 14, tablets 18, PDAs 20, cell phones and smart phones (not shown) and the like. In at least one embodiment, the server 22 includes memory and databases for storing instructions and data, the data comprising a set of programs and a dataset having one or more data fields; and processing devices or processors executing the instructions and processing the data necessary to operate the method or providing delivered pricing as provided below.

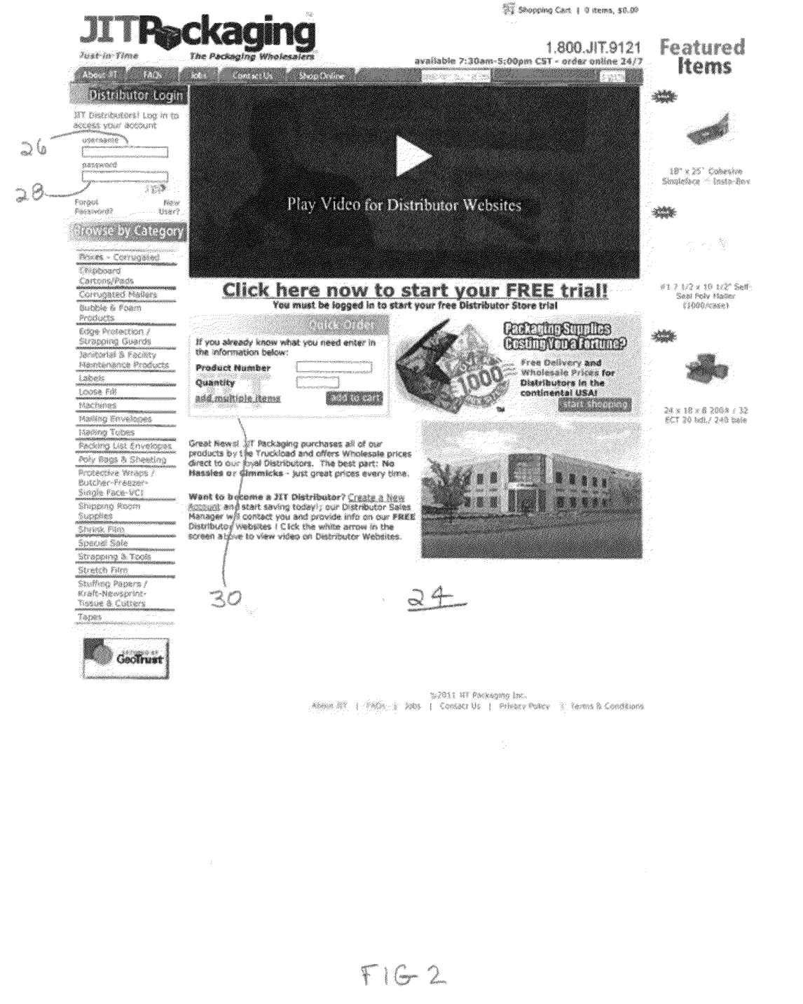

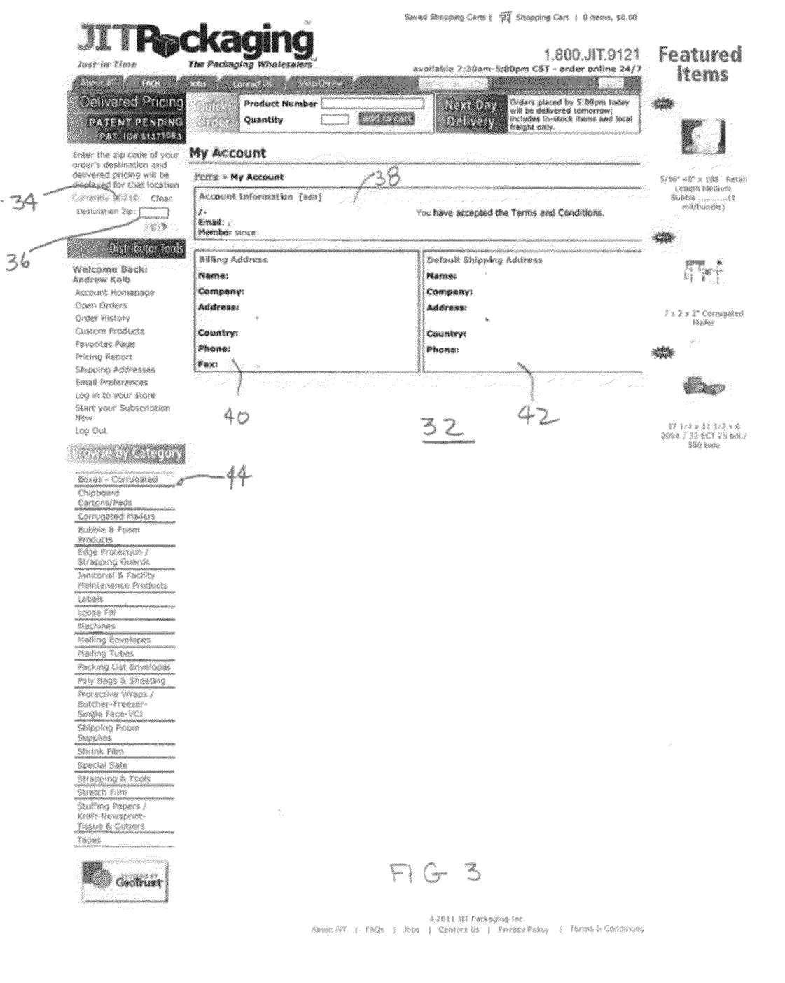

FIG. 2 depicts a screen shot of a log in screen generally designated 24 in accordance with one embodiment of the present invention. As illustrated, log in screen 24 includes a user name entry field 26 and password entry field 28. The user enters his user name in user name entry field 26 and password in password entry field 28 to access the system 10. In at least one embodiment, log in screen 24 enables the user to directly enter product number and quantity in the quick order field 30. FIG. 3 is a screen shot of an account page screen 32 in accordance with one embodiment. Screen shot 32 includes a destination zip code entry field 34. The method defaults to a previously used zip code or enables the user to enter a new delivery zip code using the destination zip code entry field 36. Screen 32 displays user account information 38, billing address information 40 and default shipping address information 42. Screen shot 32 further includes a product category selection portion 44 displaying different products by category including, boxes-corrugated, chipboard cartons/pads, bubble & foam product, edge protection, strapping guards, labels, loose fill, mailing envelopes, and the like. In at least one embodiment, the user rolls his mouse over one of the products in the product category selection portion 40 to display a plurality of different products in one or more product categories.

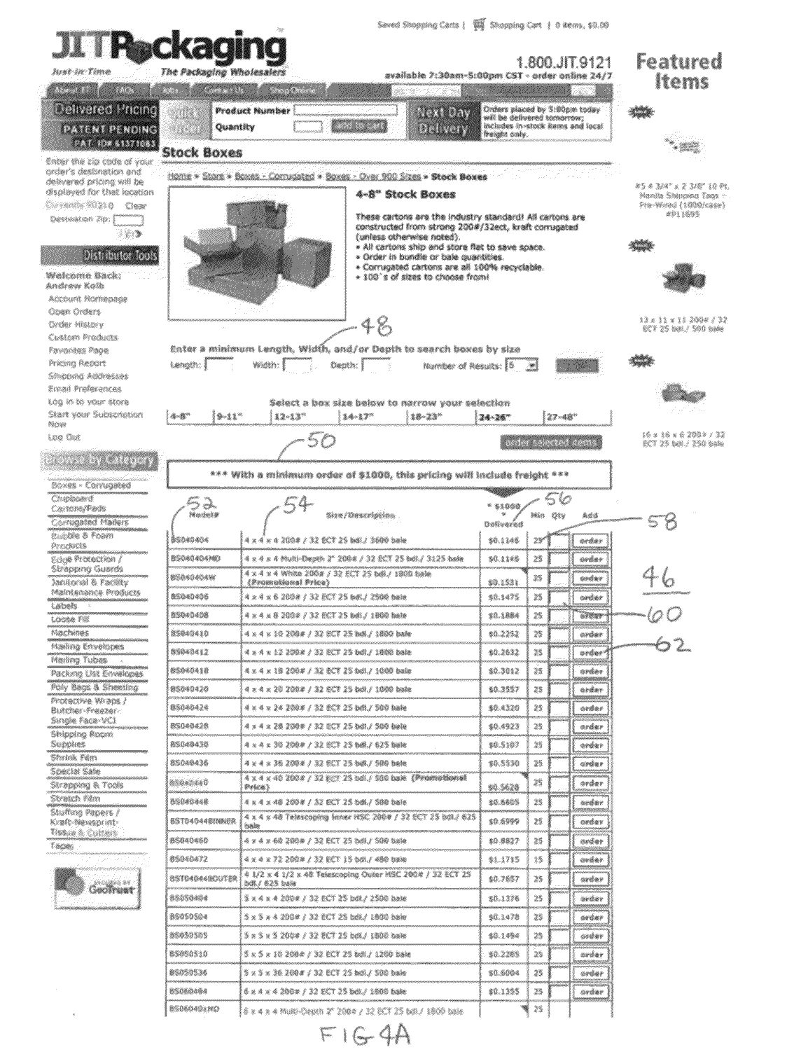

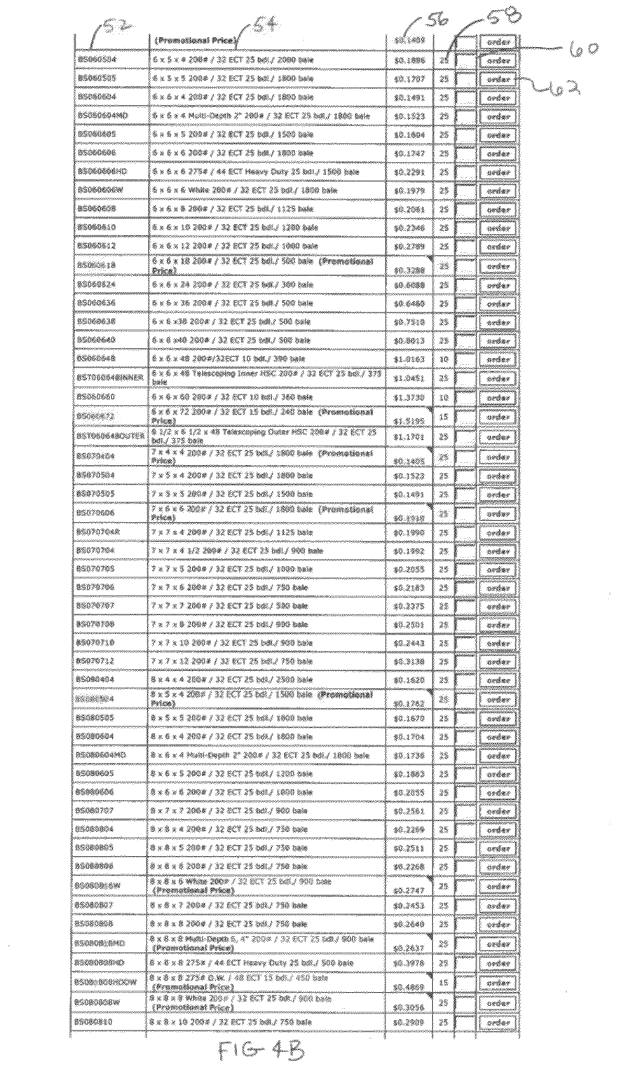

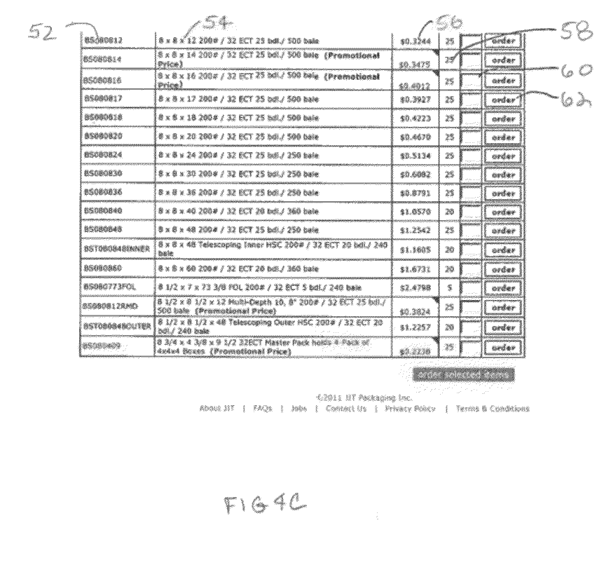

FIGS. 4A, 4B and 4C depict a screen sheet of the quantity order screen, generally designated 46, for placing orders for specific quantities of one or more products in accordance with at least one embodiment. In at least one embodiment, screen shot 46 enables a user to directly enter dimensions in one or more length, width and depth fields 48. Screen shot 46 further displays or provides a minimum threshold amount alert 50. In the illustrated embodiment, the minimum threshold alert 50 ($1000 for example although different thresholds, $300 or more, are contemplated) includes freight costs. Additionally, the screen shot 46 provides one or more model numbers 52, one or more product size and/or descriptions 54, one or more delivered unit pricing 56; one or more minimum quantities 58, one or more order entry fields 60, and one or more order buttons 62. Furthermore, in at least one embodiment, the delivery unit pricing may include at least some or all of the freight.

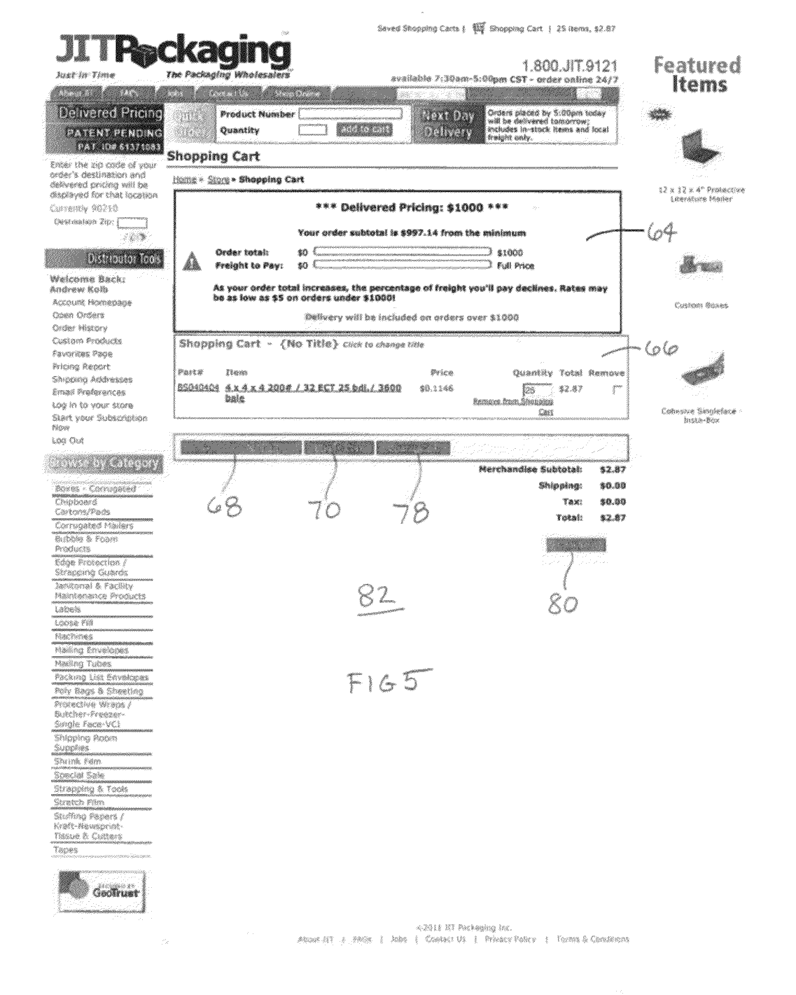

FIG. 5 depicts a screen shot illustrating an alert screen, generally designated 82, in accordance with one embodiment of the present invention. FIG. 5 depicts alert 64, shopping cart 66, a continue shopping button 68, an empty cart button 70, an update car button 78, and a check out button 80. In at least one embodiment, the alert 64 displays the order total, freight to pay and amount the order subtotal is from the minimum. In screen shot 82, the subtotal is $2.87, which is $997.14 distant, spaced or away from the threshold.

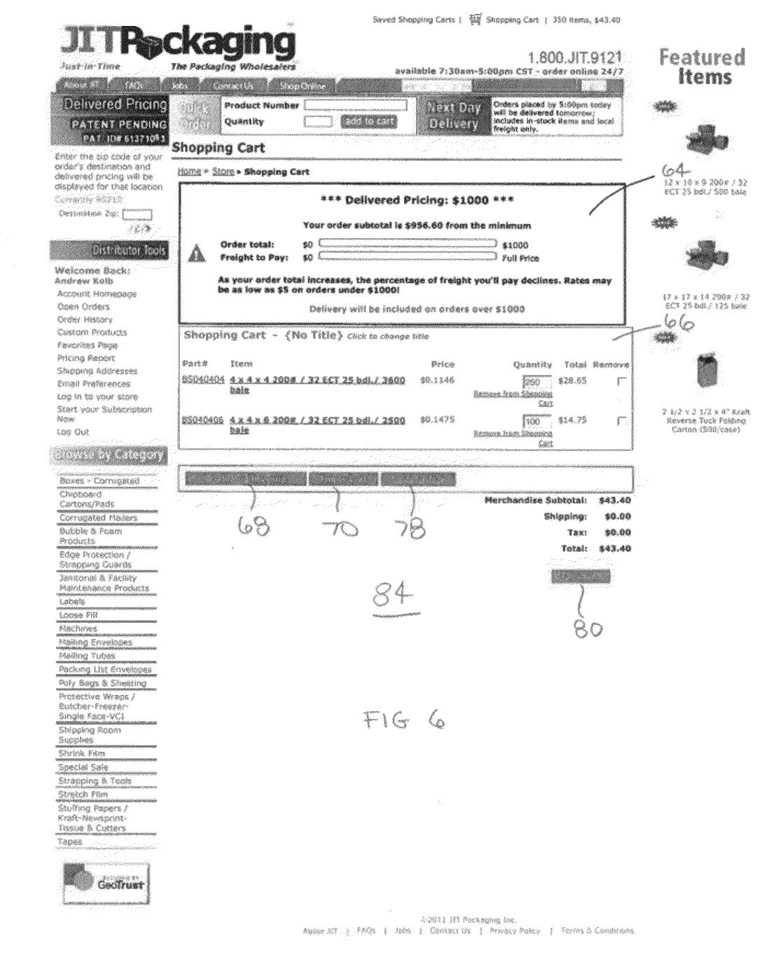

FIG. 6 depicts a screen shot of an alert and modified order screen, generally designated 84, in accordance with one embodiment of the present invention. FIG. 6 depicts alert 64 for an order (similar to that illustrated in FIG. 5) that has been altered or changed, using update cart button 78 for example. Screen shot 84 provides shopping cart 66, continue shopping button 68, empty cart button 70, update cart button 78, and check out button 80. In at least one embodiment, the alert 64 displays the order total, freight to pay and amount the order subtotal is from the minimum. In screen shot 84, the subtotal is $43.40, which is $956.60 distant, spaced or away from the threshold.

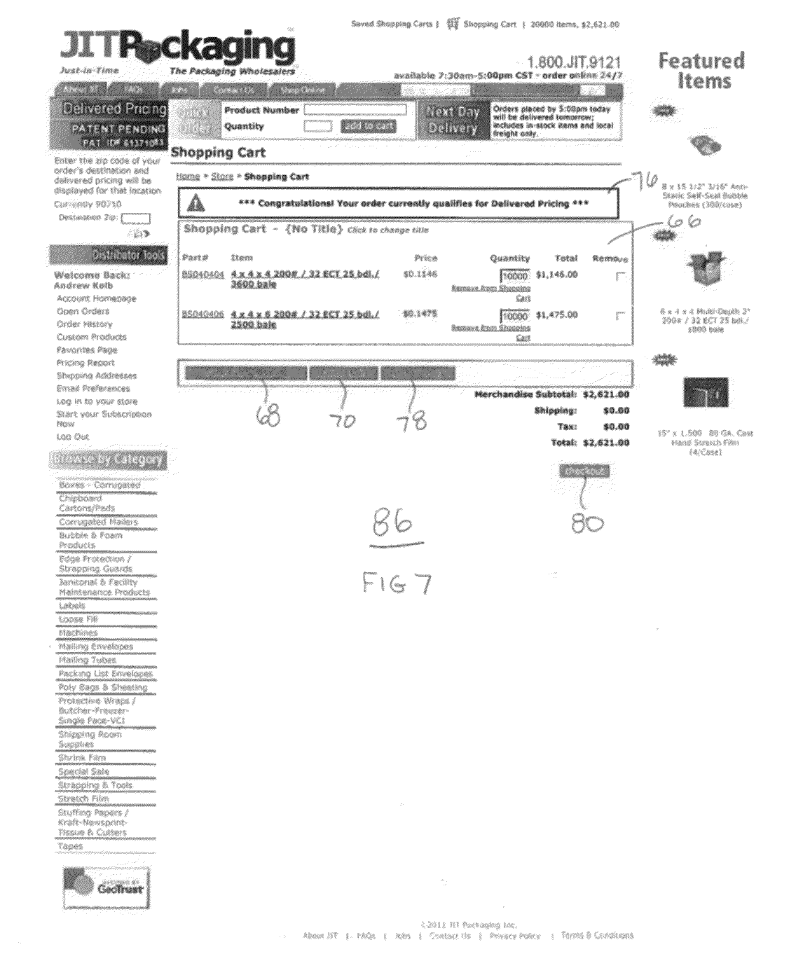

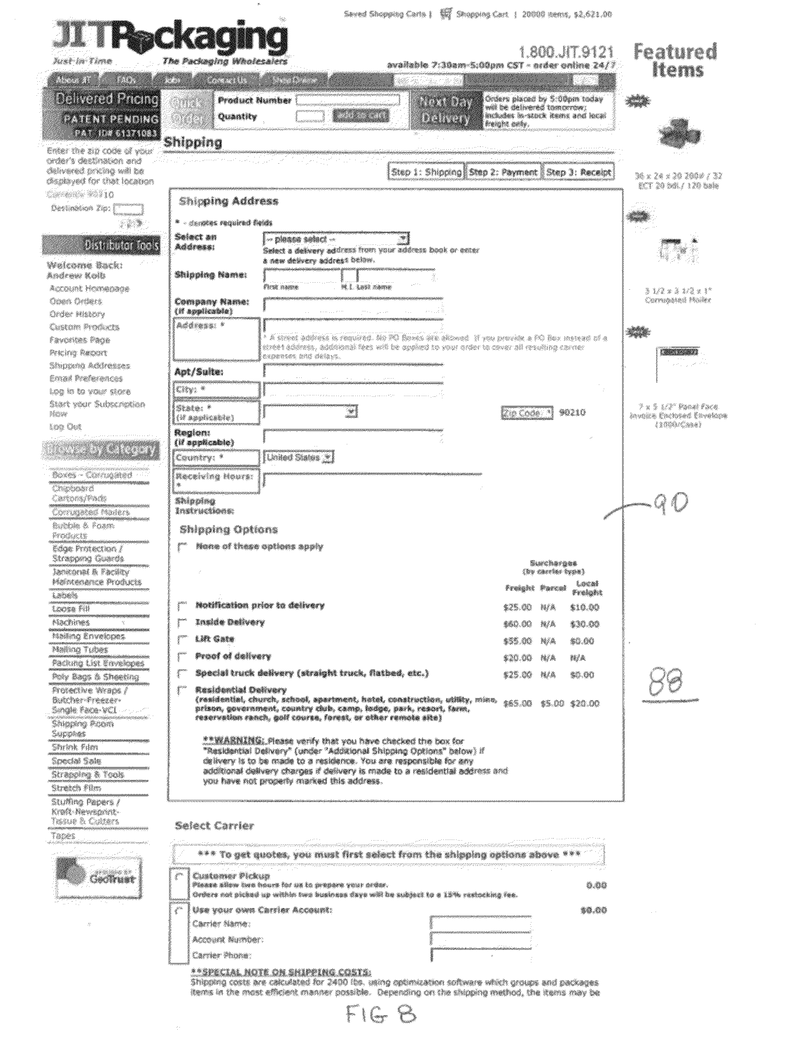

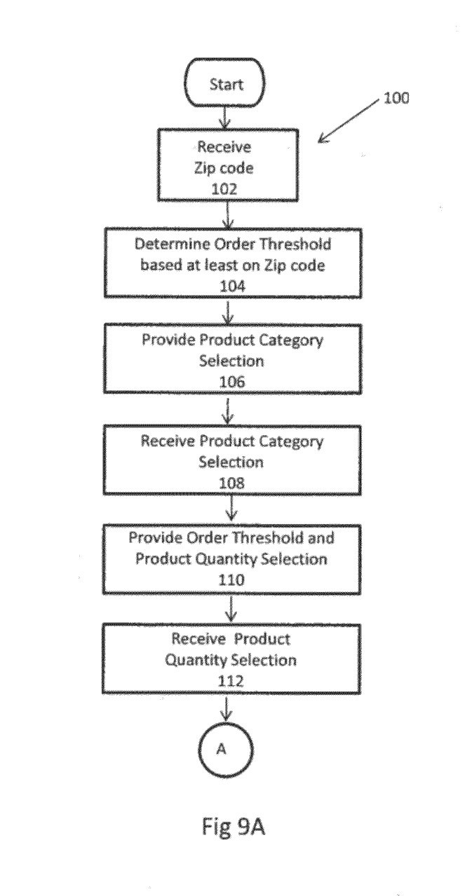

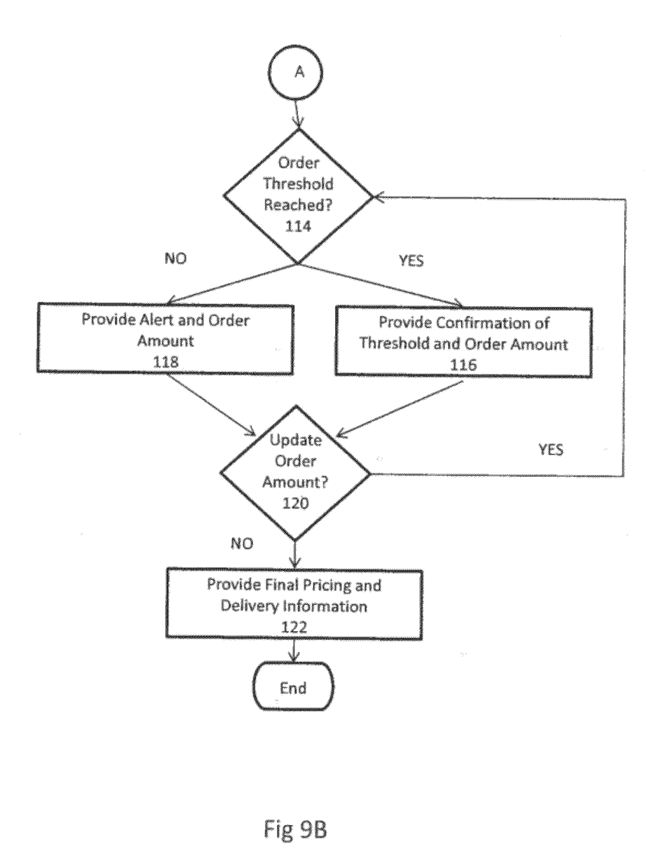

FIG. 7 depicts a screen shot of confirmation screen, generally designated 86, in accordance with one embodiment of the present invention. FIG. 7 depicts confirmation alert 76, shopping cart 66, continue shopping button 68, empty cart button 70, update cart button 78, and check out button 80. In at least one embodiment, the alert 64 displays the order total, freight to pay and amount the order subtotal is from the minimum. As illustrated, alert 76 provides that the threshold has been reached. FIG. 8 depicts a screen shot of a final pricing and delivery screen, generally designated 88, in accordance with one embodiment of the present invention. Screen sheet 88 provides shipping address field 90, that enables the user to enter shipping address and other information. FIG. 9A-9B depict a detailed flow diagram of a method, generally designated 100, for providing delivered pricing in accordance with one embodiment. Method 100 includes receiving a destination zone, a destination zip code for example, block 102. The method 100 includes determining an order threshold based at least in part on the zip code, block 104. The method 100 further includes providing a product category selection, block 106 and receiving a product category selection, block 108. Method 100 further includes providing an order threshold and product quantity selection, block 110, and receiving product quantity selection, block 112.

Method 100 further includes determining whether the order threshold has been reached, diamond 114. If the threshold has been reached, the method 100 provides a confirmation of threshold and order amount, block 116. If the threshold has not been reached, the method 100 provides an alert and order amount, block 118. Method 100 further determines if the order amount is updated, diamond 120. If the order is updated, the method 100 determines if the order threshold has been reached, block 114. If the order is not updated, the method 100 provides final pricing and delivery information, block 122.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is intended that they be deemed within the scope of this invention.

We claim:

1. A method for providing delivered pricing for at least one product, the method comprising:
receiving at least one delivery zone;
providing at least one order threshold for the at least one product, the at least one order threshold including freight costs, the threshold based at least in part on a product unit cost and a freight cost based on the received destination zone;
receiving a product quantity selection;
providing preliminary delivered pricing based at least in part on the received product quantity selection;
determining whether the preliminary delivered pricing meets or exceeds the at least one order threshold; and
providing a total order cost, wherein the total order cost includes, the delivered pricing for at least one product based at least in part on the at least one delivery zone.

2. The method of claim 1 wherein the at least one delivery zone comprises at least one zip code.

3. The method of claim 1 further comprising providing an order alert if the preliminary pricing does not meet the at least one order threshold.

4. The method of claim 3 wherein the order alert further includes at least one indicator detailing an amount required to meet the at least one order threshold.

5. The method of claim 4 further comprising altering the product quantity selection to meet the at least one order threshold.

6. The method of claim 4 further comprising entering a second product quantity selection to meet the at least one order threshold.

7. The method of claim 1 further comprises providing at least one unit pricing.

8. The method of claim 7 wherein the at least one unit pricing includes at least a portion of a freight cost.

9. A computer readable storage medium comprising computer executable instructions, which when executed by a computer cause the computer to perform a method for providing delivered pricing for at least one product, comprising:
receiving at least one delivery zone;
providing at least one order threshold for the at least one product, the at least one order threshold including freight costs, the threshold based at least in part on a product unit cost and a freight cost based on the received destination zone;
receiving a product quantity selection;
providing preliminary delivered pricing based at least in part on the received product quantity selection;
determining whether the preliminary delivered pricing meets or exceeds the at least one order threshold; and
providing a total order cost, wherein the total order cost includes, the delivered pricing for at least one product based at least in part on the at least one delivery zone.

10. The computer readable storage medium of claim 9 wherein the at least one delivery zone comprises at least one zip code.

11. The computer readable storage medium of claim 9 further comprising providing an order alert if the preliminary pricing does not meet the at least one order threshold.

12. The computer readable storage medium of claim 11 wherein the order alert further includes at least one indicator detailing an amount required to meet the at least one order threshold.

13. The computer readable storage medium of claim 12 further comprising altering the product quantity selection to meet the at least one order threshold.

14. The computer readable storage medium of claim 13 further comprising entering a second product quantity selection to meet the at least one order.

15. The computer readable storage medium of claim 9 further comprises providing at least one unit pricing.

16. The computer readable storage medium of claim 15 wherein the at least one unit pricing includes at least a portion of a freight cost.

17. A system for providing delivered pricing for at least one product, the system comprising:
a server having instructions operating thereon providing delivered pricing for at least one product, the instructions performing the method comprising:
receiving at least one zip code;
providing at least one order threshold for the at least one product, the at least one order threshold including freight costs, the threshold based at least in part on a product unit cost and a freight cost based on the received destination zone;
receiving a product quantity selection;
providing preliminary delivered pricing based at least in part on the received product quantity selection;
determining whether the preliminary delivered pricing meets or exceeds the at least one order threshold; and
providing a total order cost, wherein the total order cost includes, the delivered pricing for at least one product based at least in part on the at least one delivery zone.

18. The system of claim 17 further comprising providing an order alert if the preliminary pricing does not meet the at least one order threshold.

19. The system of claim 18 wherein the order alert further includes at least one indicator detailing an amount required to meet the at least one order threshold.
